(19) United States
(12) Patent Application Publication
(10) Pub. No.: US 2012/0217027 A1
(43) Pub. Date: Aug. 30, 2012

(54) EXTENDED DISCHARGE OF ODORANT

(75) Inventors: Adam Chattaway, Windsor (GB); Robert Glaser, Stella, NC (US); Paul Rennie, Bracknell (GB); Josephine Gabrielle Gatsonides, Dunstable (GB)

(73) Assignee: KIDDE TECHNOLOGIES, INC., Wilson, NC (US)

(21) Appl. No.: 13/033,652

(22) Filed: Feb. 24, 2011

(51) Int. Cl. A62C 3/00; A62C 31/00

(52) U.S. Cl. 169/46; 169/70

(57) ABSTRACT

A method for fire suppression includes flowing a first inert gas output into an enclosed space at a high rate of discharge and flowing a second inert gas output into the enclosed space at a low rate of discharge. The method further includes metering an odorant into the second inert gas to provide an extended warning that inert gas is present in the enclosed space.

### BACKGROUND

The present disclosure relates to fire suppression systems and more particularly to the use of odorants in fire suppression systems.

Fire suppression systems are often included in aircraft, buildings, or industrial structures having contained areas. A variety of fire suppression systems using different extinguishing agents and methods are known. Since fire propagation requires oxygen, some fire suppression systems use inert gases to dilute the supply of oxygen and suppress the fire.

### SUMMARY

A method for fire suppression in an enclosed space is disclosed. The method for fire suppression includes flowing a first inert gas output into the enclosed space at a high rate of discharge, and flowing a second inert gas output into the enclosed space at a low rate of discharge. The method further includes metering an odorant into the second inert gas output to provide an extended odiferous warning that inert gas is present in the enclosed space.

A system for fire suppression in an enclosed space is also disclosed. The fire suppression system includes a high rate discharge delivery system, a low rate discharge delivery system, and an odorant discharge delivery system. The high rate discharge delivery system supplies a first inert gas output at a high discharge rate to the enclosed space. The low rate discharge delivery system supplies a second inert gas output at a low discharge rate to the enclosed space. The odorant discharge delivery system supplies an odorant to the enclosed space by releasing the odorant into the second inert gas output thereby providing an extended odiferous warning that inert gas is present in the enclosed space.

The system for fire suppression can further include a fire detector located in the enclosed space. In this system, the high rate discharge delivery system supplies a first inert gas output at a high discharge rate to the enclosed space in response to a signal from the fire detector that a fire event has occurred. The first inert gas output is configured for immediate suppression of the fire event in the enclosed space. The low rate discharge delivery system supplies a second inert gas output at a low discharge rate to the enclosed space after the first inert gas output. The second inert gas output is configured for continuing suppression of the fire event in the enclosed space. The odorant discharge delivery system includes a delivery device for metering the odorant into the second inert gas output thereby providing an extended odiferous warning that inert gas is present in the enclosed space.

### BRIEF DESCRIPTION OF THE DRAWINGS

FIG. 1 is a perspective view of an airplane having a fire suppression system in accordance with the present disclosure.

FIG. 2 is a schematic of the fire suppression system including an odorant discharge delivery device.

FIG. 3A is a schematic of a first embodiment of the odorant discharge delivery device: a syringe pump.

FIG. 3B is a schematic of a second embodiment of the odorant discharge delivery device: venturi area.

FIG. 3C is a schematic of a third embodiment of the odorant discharge delivery device: porous medium.

FIG. 3D is a schematic of a fourth embodiment of the odorant discharge delivery device: metering valve.

FIG. 3E is a schematic of a fifth embodiment of the odorant discharge delivery device: pressure operated syringe injector.

FIG. 4 is a flow chart showing a method of fire suppression in accordance with the present invention.

### DETAILED DESCRIPTION

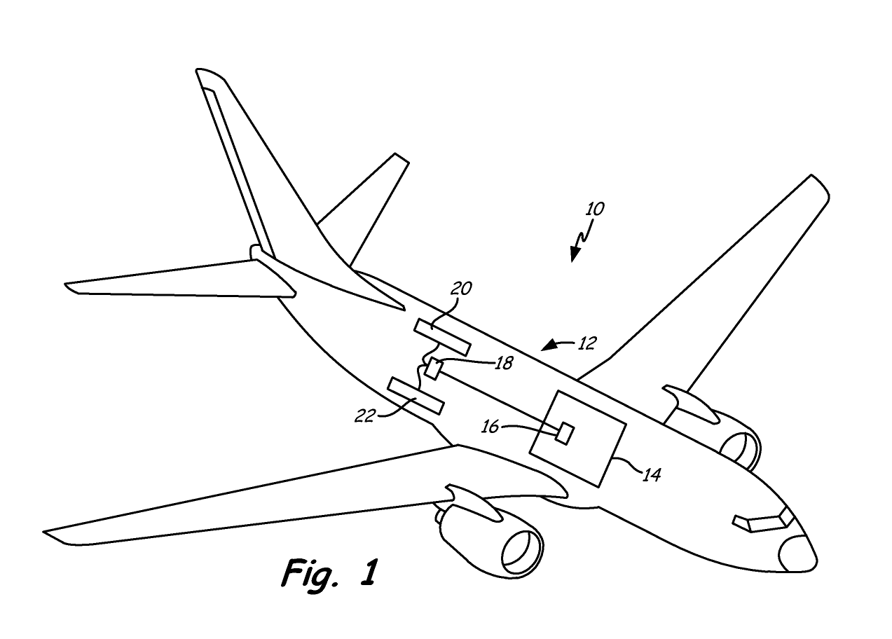

FIG. 1 is a perspective view of airplane 10 having fire suppression system 12 for enclosed space 14. Fire suppression system 12 includes fire detector 16, controller 18, high rate discharge (HRD) delivery system 20, and low rate discharge (LRD) delivery system 22. In case of a fire event within enclosed space 14 (such as a cargo bay) of aircraft 10, fire suppression system 12 is activated.

Fire detector 16 is located within space 14, while controller, HRD delivery system 20, and LRD delivery system 22 are located outside of space 14. Fire detector 16 senses the fire event within space 14 from a presence of smoke, heat, or other change in the local environment. Fire detector 16 sends a signal to controller 18 that the fire event has been detected and fire suppression system 12 should be activated. Controller 18 sends a first signal to HRD delivery system 20 requesting a high rate of discharge of a fire suppression agent for immediate fire suppression. Controller 18 sends a second, subsequent signal to LRD delivery system 22 requesting a low rate of discharge of a fire suppression agent for continuing fire suppression. HRD delivery system 20 and LRD delivery system 22 are configured to work together as unified fire suppression system 12 to extinguish and/or suppress fire events within enclosed space 14 of aircraft 10.

Fire propagation requires oxygen. Fire suppression system 12 is configured to reduce oxygen by introducing inert gas to enclosed space 14. HRD delivery system 20 and LRD delivery system 22 both flow inert gases such as nitrogen, helium, argon or the like into enclosed space 14 to suppress the propagation of fire. HRD delivery system 20 is a “first line defense” because it releases a first inert gas output at a high discharge rate to enclosed space 14 in response to the initial signal from controller 18. The purpose of HRD delivery system 20 is an immediate reduction of oxygen and control over fire propagation. LRD delivery system 22 is a “second line defense” because it releases a second inert gas output at a low discharge rate to enclosed space 14 in response to a second signal from controller 18. The purpose of LRD delivery system 22 is continuing the low oxygen environment established by HRD delivery system 20, thereby exerting lasting control over fire propagation. Use of fire suppression system 12 will result in accumulation of inert gases within enclosed space 14, which pose a danger to human health. A worker entering enclosed space 14 may not be aware of the presence of inert gases and/or the lack of oxygen and suffer deleterious health effects. Inclusion of an odorant in fire suppression system 12 warns humans of the presence of inert gases and/or the lack of oxygen in enclosed space 14.

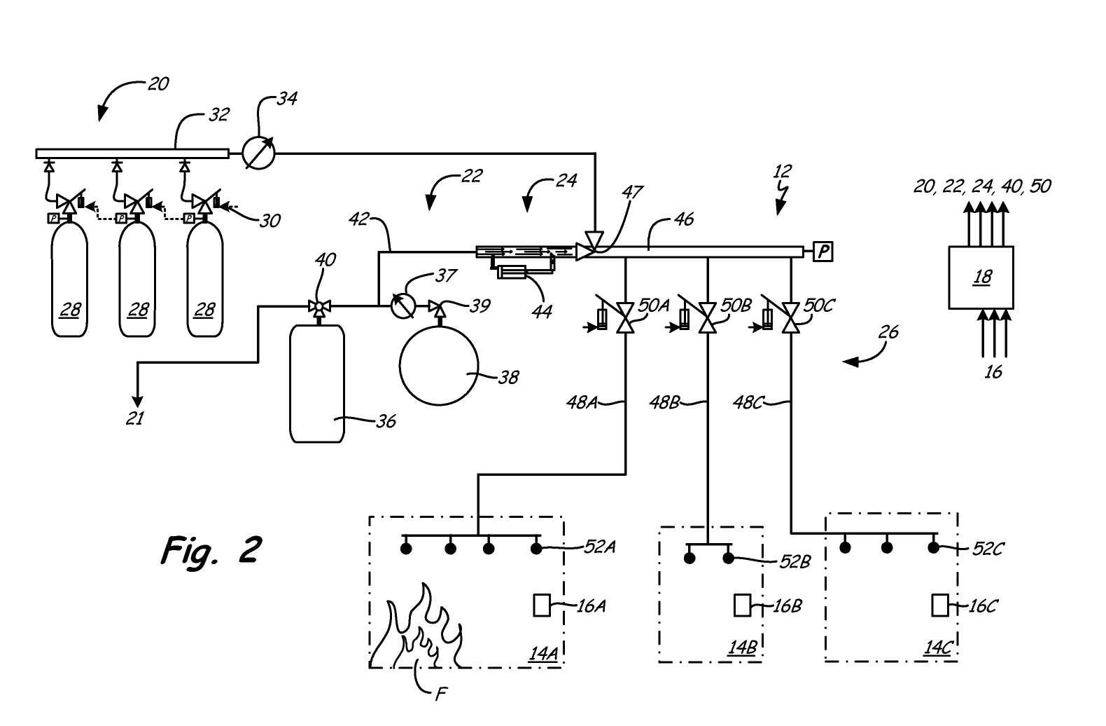

FIG. 2 is a schematic of fire suppression system 12 including controller 18, HRD delivery system 20, LRD delivery system 22, and odorant delivery system 24. Depicted in FIG. 2 are enclosed spaces 14A, 14B, 14C, fire detectors 16A, 16B, 16C, HRD delivery system 20, fuel tanks 21, LRD delivery system 22, odorant delivery system 24, and distribution ducting 26. HRD delivery system 20 further includes HRD pressure vessels 28, HRD discharge valves 30, HRD collector 32, and HRD regulator valve 34. LRD delivery system 22 further includes LRD nitrogen enriched air (NEA) source 36, LRD regulator valve 37, optional LRD pressure vessel 38, LRD discharge valve 39, LRD selector valve 40, and LRD distributor 42. Odorant delivery system 24 includes odorant delivery device 44. Distribution ducting 26 includes separate HRD delivery system 20 and LRD delivery system 22 branches both feeding main conduit 46 and meeting at non-return valves 47. Main conduit separates into branch conduits 48A, 48B, 48C, having diverter valves 50A, 50B, 50C, and nozzles 52A, 52B, 52C. HRD delivery system 20 and LRD delivery system 22 release inert gases to suppress fire event F in enclosed space 14A, and odorant delivery system 24 releases an odorant to warn humans that inert gases are present in enclosed space 14A.

HRD delivery system 20 includes a plurality of HRD pressure vessels 28, each containing a volume of inert gas at a high pressure. Each HRD pressure vessel 28 has an associated HRD discharge valve 30 and a conduit connecting the HRD pressure vessel 28 to HRD collector 30. A signal from controller 18 indicates the occurrence of fire event F in enclosed space 14A and causes discharge valves 30 to release gas from HRD pressure vessel 28 into HRD collector 32. Inert gas is collected in HRD collector 32 and released by HRD regulator valve 34 as a first inert gas output that flows through conduit 46 and through distribution ducting 26 to enclosed spaced 14A. The first inert gas output is provided to enclosed space 14A at a high rate of discharge, but only for a short duration. The HRD delivery system 20 is intended to provide quick, strong burst of inert gas for immediate suppression of fire event F.

LRD delivery system 22 is located on a separate branch from HRD delivery system 20. In the depicted embodiment LRD delivery system 22 includes both LRD NEA source 36 and LRD pressure vessel 38. In an alternative embodiment, either LRD NEA source 36 or LRD pressure vessel 38 are present in LRD delivery system 22, but not both. LRD NEA source 36 supplies a volume of nitrogen enriched air while LRD pressure vessel 38 contains a volume of inert gas under pressure. Under normal conditions, LRD NEA source 36 is likely to be running continuously and NEA is diverted by selector valve 40 to areas such as fuel tanks 21 which require continuous inerting. Upon detection of a fire signal from controller 18, NEA from LRD NEA source 36 is redirected by selector valve 40 for use in controlling fire event F. After HRD delivery system 20 has released the first inert gas output to enclosed space 14A, controller 18 causes LRD selector valve 40 to release NEA from LRD NEA source 36 and/or inert gas from LRD pressure vessel 38 as a second inert gas output. LRD discharge valve 39 opens to allow flow of inert gas from LRD pressure vessel 38 and LRD regulator valve opens to allow flow of inert gas into LRD distributor. The second inert gas output flows to distribution ducting 46, through non-return valves 47 and to enclosed space 14A. This second inert gas output is provided to enclosed space 14A at a low rate of discharge and for a long duration. The LRD delivery system 22 is intended to provide a slow, lasting flow of inert gas for continued suppression of fire event F.

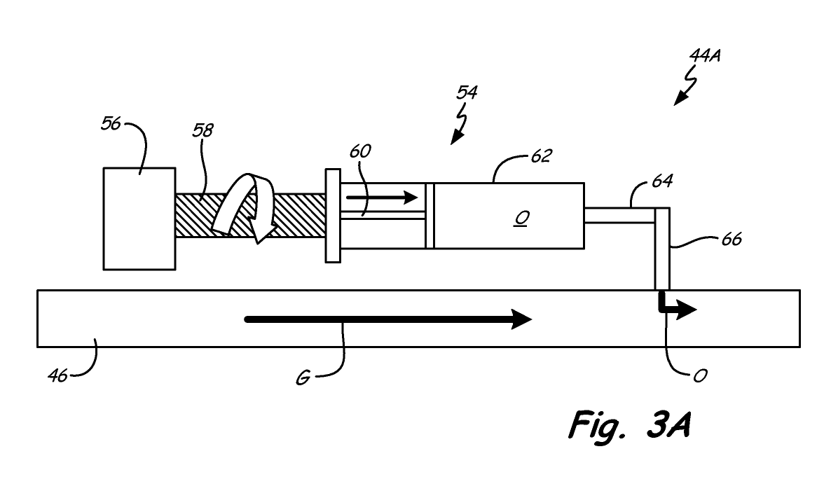

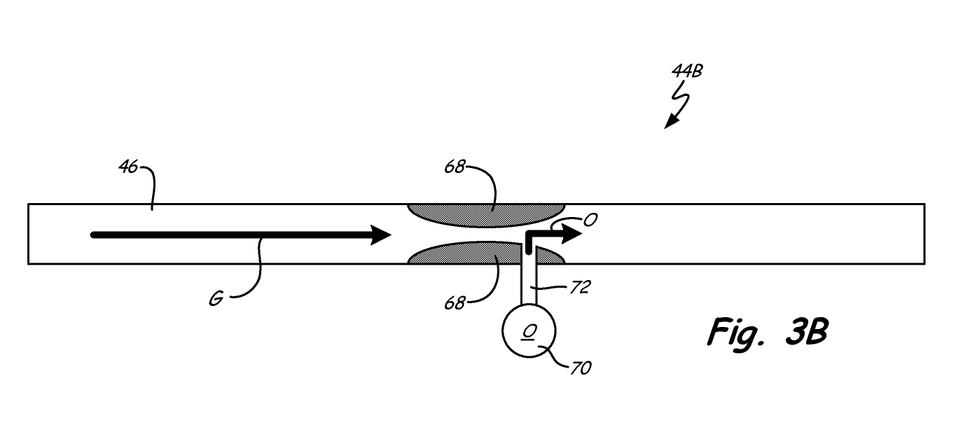

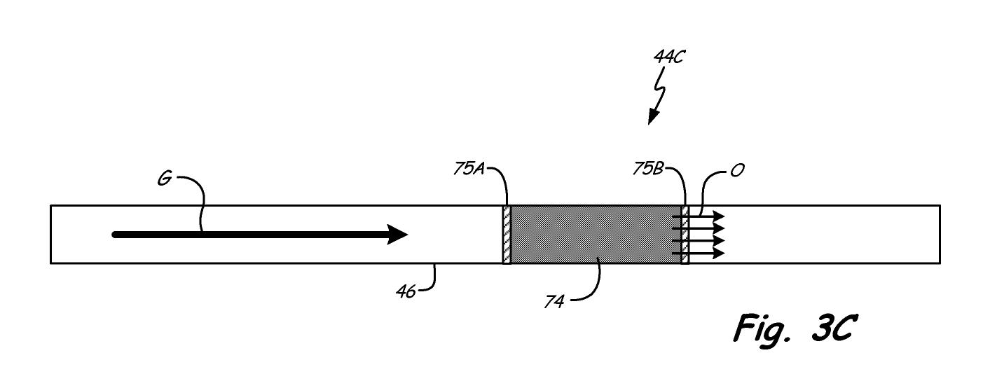

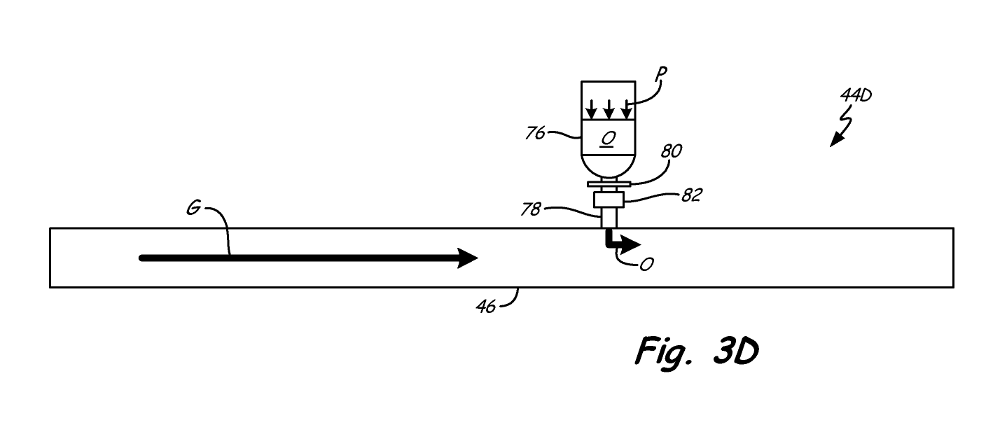

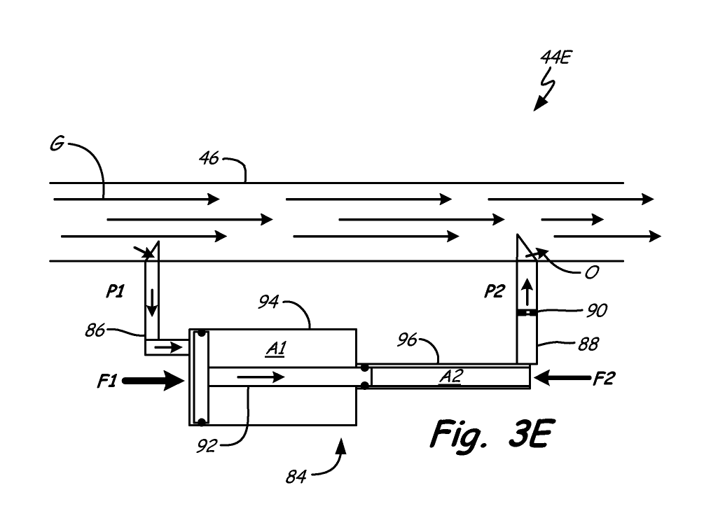

Odorant delivery system 24 is located in the LRD branch of the distribution system, downstream of LRD delivery system 22 and upstream of non-return valve 47. Odorant delivery device 44 contains an odorant and a means for metering the odorant into the second gas output. Several embodiments of odorant delivery device 44 are discussed below with reference to FIGS. 3A-3E. Controller 18 activates the release of the odorant from odorant delivery system 24 either in conjunction with the initiation of LRD delivery system 22 or sometime thereafter. The odorant exits odorant delivery device 44 and mixes with the second inert gas output at LRD distributor 42. The combined odorant and second inert gas output flow to enclosed space 14A through distribution ducting 26. Since the odorant is metered into the second inert gas output (in contrast to the first inert gas output), the odorant will flow to enclosed space 14a in slow, extended, and lasting manner. The odorant, therefore, lingers within enclosed space 14a to provide an extended odiferous warning of the presence of inert gas/or lack of oxygen.

FIG. 2 depicts three enclosed spaces 14A, 14B, and 14C having fire detectors 16A, 16B, 16C, respectively. Enclosed spaces 14A, 14B, and 14C represent any enclosed space on aircraft 10 having fire suppression system 12 (e.g. cargo bay or equipment space). Distribution ducting 26 provides a fluid connection between HRD delivery system 20, LRD delivery system 22, odorant delivery system 24 and enclosed spaces 14A, 14B, 14C. Main conduit 46 extends from at least non-return valve 47 and splits into branch conduits 48A, 48B, 48C to each of enclosed spaces 14A, 14B, 14C, respectively. Each branch conduct 48A, 48B, 48C includes diverter valve 50A, 50B, 50C and terminates in nozzles 52A, 52B, 52C, respectively. Controller 18 opens diverter valve 50 on whichever branch conduit 48A, 48B, 48C is associated with the enclosed space 14A, 14B, 14C experiencing the fire event. In the depicted embodiment, fire event F is detected by fire detector 16A in enclosed space 14A, which signals controller 18 to begin fire suppression system 12. Diverter valve 50A on branch conduit 48A will move to the open position while diverter valves 50B and 50C on branch conduits 48B and 48C will remain closed. The first inert gas output from HRD delivery system 20, the second inert gas output from LRD delivery system 22, and the odorant from odorant delivery system 24 will travel through main conduit 46, through opened diverter valve 50A on branch conduit 48A, and out of nozzles 52A in enclosed space 14A.

FIG. 3A is a schematic of a first embodiment of odorant discharge delivery device 44A, syringe pump 54, attached to main conduit 46. Syringe pump 54 includes motor 56, screw 58, plunger 60, tube 62, needle 64, and connecting conduit 66. Syringe pump 54 meters odorant O into second inert gas output G in main conduit 46. Second inert gas output G and odorant O are delivered to an enclosed space (e.g. enclosed space 14A) where the presence of odorant O warns humans of the presence of second inert gas output G and/or lack of oxygen.

Syringe pump 54 includes motor 56 attached to a first end of screw 58. A second, opposite end of screw 58 is attached to a first end of plunger 60. A second, opposite end of plunger 60 is in contact with odorant O contained within tube 62. Plunger 60 is located within and movable across a volume of tube 62. A first end of tube 62 is attached to the second end screw 58 and a second, opposite end of tube 62 is attached to a first end of needle 64. A second end of needle 64 is attached to a first end of connecting conduit 66. A second end of connecting conduit 66 is attached to main conduit 46. A seal and/or restrictor can be included at outlet of conduit 66. Syringe pump 54 is configured to slowly discharge odorant O into main conduit 46 for mixing with second inert gas output G.

Concurrent with (or shortly after) activation of LRD delivery system 22, controller 18 activates syringe pump 54 to slowly administer odorant O into main conduit 46. Motor 56 drives threaded screw 58 forward, which slowly pushes plunger 60 forward across tube 62. As plunger 60 is driven into tube 62, odorant O within tube 62 is slowly pushed out the other end into needle 64. From needle 64, odorant O flows into connecting conduit 66 and joins second gas output G in main conduit 46. When second inert gas output G flows past the point of connection between connecting conduit 66 and main conduit 46, odorant O mixes into second gas inert gas output G. Syringe pump 54, therefore, meters odorant O into second inert gas output G, such that an extended odiferous warning in the form of odorant O is delivered to the enclosed space along with second inert gas output G.

FIG. 3B is a schematic of a second embodiment of the odorant discharge delivery device 44B, which includes venturi area 68 and reservoir 70. Venturi area 68 is located within main conduit 46 and vented or pressurized reservoir 70 is attached to main conduit 46 by connecting conduit 72 just downstream of venturi area 68. The presence of venturi area 68 in main conduit 46 reduces local pressure and induces odorant O out of reservoir 70 through connecting conduit 72 and into second inert gas output G.

Venturi area 68 is a narrowing of the inner walls of main conduit 46. Just downstream of venturi area 68, reservoir 70 is attached to an outer wall of main conduit 46. Reservoir contains a volume of odorant O. Connecting conduit 72 fluidly connects reservoir 70 to main conduit 46. Second inert gas output G experiences a local increase in velocity and corresponding decrease in pressure as it passes through the restricted venturi area 68 within main conduit 46. As second inert gas output G exits venturi area 68, it pulls odorant O out of reservoir 70, which is at a slighter higher pressure. Odorant O is slowly expelled from reservoir 70 through connecting conduit 72 and into inert gas output G within main conduit 46. An on/off valve can be located on connecting conduit 72 and operated by controller 18 to coordinate release of odorant O with second inert gas output G. Accordingly, an extended odiferous warning in the form of odorant O is discharged to an enclosed space (such as enclosed space 14A) along with second inert gas output G.

FIG. 3C is a schematic of a third embodiment of odorant discharge delivery device 44C, porous medium 74, and seals 75A and 75B located within main conduit 46. Porous medium 74 is a plug, sinter, or sponge containing odorant O and attached to inner walls of main conduit 46 with odorant O sealed in. When activated, the second inert gas output G breaks both of seals 75A and 75B and then flows through porous medium 74. The odorant O is slowly pulled out of porous medium 74 and released into second gas output G. An extended odiferous warning in the form of odorant O is delivered to the enclosed space along with second inert gas output G.

FIG. 3D is a schematic of a fourth embodiment of odorant discharge delivery device 44D including reservoir 76 and connecting conduit 78. Reservoir 76 contains odorant O and pressure gas P. Connecting conduit 78 includes on/off valve 80 and metering valve 82. Odorant O is slowly discharged from reservoir 76 through metering valve 82 and into second inert gas output G in main conduit 46.

Reservoir 76 is fluidly attached to main conduit 46 by connecting conduit 78. Located within reservoir 76 is both odorant O and pressurized gas P. Located on connecting conduit 78 next to reservoir 76 is on/off valve 80. Located on connecting conduit 78 between on/off valve 80 and the connection to main conduit 46 is metering valve 82. In response to a signal from controller 18, on/off valve 80 moves to an open position. Nitrogen or another pressurized gas G exerts force on odorant O such that odorant O exits reservoir 76, passes through open on/off valve 80 and enters metering valve 82. Metering valve 82 controls the flow of odorant O into second inert gas output G in main conduit 46. Accordingly, an extended odiferous warning in the form of odorant O is delivered to an enclosed space (such as enclosed space 14A) along with second inert gas output G.

FIG. 3E is a schematic of a fifth embodiment of odorant discharge delivery device 44E: pressure operated syringe injector 84. Depicted in FIG. 3E are main conduit 46, first connecting conduit 86, and second connecting conduit 88 containing seal 90 and metering means, which might be a valve or a metering orifice. Syringe injector 84 includes plunger 92, first tube portion 94, and second tube portion 96. Syringe injector 84 uses proportional pressure to slowly discharge odorant O into second inert gas output G.

Syringe injector 84 is fluidly connected to main conduit 46 by first connecting conduit 86 and second connecting conduit 88. A first end of first connecting conduit 86 is attached to main conduit 46, and a second end of first connecting conduit 86 is attached to a first end of syringe injector 84. A first end of second connecting conduit 88 is attached to a second end of syringe injector 84 and a second end of connecting conduit 88 is attached to main conduit 46. Located within second connecting conduit 88 is seal and restrictor 90. The first end of syringe injector 84 includes plunger 92 located within first tube portion 94, which has area A1. The second end of syringe injector 84 includes second tube portion 96 having area A2 and containing odorant O. Area A1 of first tube portion 94 is greater than area A2 of second tube portion 96. Proportional pressure of second inert gas flow G causes plunger 92 to eject odorant O from syringe injector 84.

Second inert gas output G flows through main conduit 46 on its way to suppress a fire event in an enclosed space. A portion of second inert gas output G flows into first connecting conduit 86 and exerts force F1 on the first end of plunger 92. Force F1 is equal to pressure P1 of second inert gas output G at first connecting conduit 86 multiplied by area A1 of first tube portion 94. Force F1 is greater than force F2, which is equal to pressure P2 of second inert gas output G at second connecting conduit 88 multiplied by area A2 of second tube portion 96. Because force F1 is greater, second inert gas output G slowly pushes plunger 92 forward across first tube portion 94 and into second tube portion 96. First tube portion 14 includes a vent adjacent second tube portion 96 to prevent pressure build up in the cavity as plunger 92 moves from left (full) to right (empty). Odorant O is ejected from second tube portion 96 and into second connecting conduit 88 where it ruptures seal 90. Odorant O passes through ruptured seal and restrictor 90 and into second inert gas flow G in main conduit 46. An extended odiferous warning in the form of odorant O is, therefore, delivered to an enclosed space (such as enclosed space 14A) along with second inert gas output G.

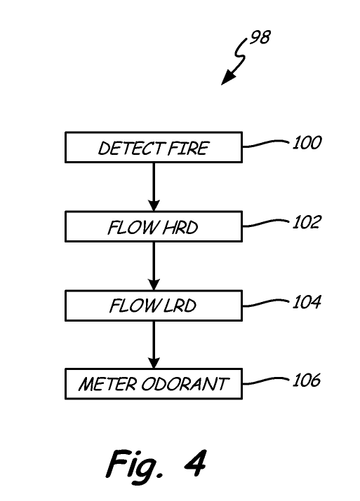

FIG. 4 is a flow chart showing fire suppression method 98 in accordance with the present disclosure. Method 98 includes detecting a fire event (step 100), flowing a first inert gas output from HRD delivery system (step 102), flowing a second inert gas output from LRD delivery system (step 104), and metering odorant into the second inert gas output (step 106). Inclusion of odorant in the second inert gas output ensures an extended odiferous warning that inert gas is present in the enclosed space.

Method 98 is intended to suppress a fire event in an enclosed space, such as fire event F in enclosed space 14A of aircraft 10. First, a fire event is detected (step 100) in an enclosed area such as a cargo bay by a smoke detector or the like. Second, a flow of a first inert gas output is ducted to the enclosed space at a high rate of discharge (step 102). This first inert gas output is intended to immediately reduce the amount of oxygen in the enclosed space in an attempt to extinguish or at least suppress the propagation of the fire event. Third, a flow of a second inert gas output is ducted to the enclosed space at a low rate of discharge (step 104). The second inert gas output is intended to maintain the depleted oxygen level in the enclosed space for the remaining duration of the flight such that the fire is suppressed and does not reignite or spread. Either concurrently with step 104 or shortly thereafter, an odorant is metered into the second inert gas output (step 106) to provide an extended odiferous warning that inert gas is present in the enclosed space. When a door to the enclosed space is opened, such as a cargo bay door, the odorant will warn humans of the presence of inert gas and/or lack of oxygen.

One benefit of using odorants for a warning is the low threshold of odor perception, typically a few parts-per-million (ppm). Very small quantities of odorants are needed to provide an effective warning to humans. Preliminary calculations indicate that approximately 20 grams (less than one ounce) of a typical odorant is sufficient to odorize a typical cargo bay compartment for as long as 330 minutes. The longest Extended Twin (Engine) Operations (ETOPS) time period (330 minutes) is therefore, the longest amount of time that a LRD delivery system would be required to provide a second inert gas output for continuing fire suppression. Since weight is critical in aviation applications, use of an extended odorant discharge warning system is particularly advantageous.

Although the present invention has been described with reference to preferred embodiments, workers skilled in the art will recognize that changes may be made in form and detail without departing from the spirit and scope of the invention.

1. A method for fire suppression in an enclosed space, the method comprising:
flowing a first inert gas output into the enclosed space at a high rate of discharge;
flowing a second inert gas output into the enclosed space at a low rate of discharge; and
metering an odorant into the second inert gas output to provide an extended odiferous warning that inert gas is present in the enclosed space.

2. The method of claim 1, wherein metering the odorant includes pushing the odorant out of a syringe.

3. The method of claim 2, wherein the syringe is pressure operated.

4. The method of claim 1, wherein metering the odorant includes reducing local pressure to induce flow of the odorant out of a reservoir.

5. The method of claim 1, wherein metering the odorant includes flowing the second inert gas output through a porous plug to pull the odorant out of the porous plug.

6. The method of claim 1, wherein metering the odorant includes the metering the odorant from a reservoir through a metering valve.

7. The method of claim 1, wherein the enclosed space is located on an aircraft.

8. A system for fire suppression in an enclosed space, the system comprising:
a high rate discharge delivery system for supplying a first inert gas output at a high discharge rate to the enclosed space;
a low rate discharge delivery system for supplying a second inert gas output at a low discharge rate to the enclosed space; and
an odorant discharge delivery system for supplying an odorant to the enclosed space, wherein the odorant discharge delivery system releases odorant into the second inert gas output thereby providing an extended odiferous warning that inert gas is present in the enclosed space.

9. The system of claim 8, further comprising:
a distribution network fluidly connecting the high rate discharge delivery system, and the low rate discharge delivery system, and the odorant discharge delivery system to the enclosed space.

10. The system of claim 9, wherein the odorant discharge delivery system is located on the distribution network downstream of the low rate discharge delivery system.

11. The system of claim 10, wherein the odorant discharge delivery system includes an odorant delivery device attached to the distribution network, the odorant delivery device for metering the release of odorant into the second inert gas output.

12. The system of claim 11, wherein the odorant delivery device includes a syringe pump containing the odorant.

14. The system of claim 11, wherein the odorant delivery device includes a venturi upstream of a reservoir containing the odorant.

15. The system of claim 11, wherein the odorant delivery device includes a porous plug containing the odorant.

16. The system of claim 11, wherein the odorant delivery device includes a metering valve attached to a reservoir containing the odorant.

17. The system of claim 11, wherein the odorant delivery device includes a proportional pressure operated syringe injector containing the odorant.

18. The system of claim 8, wherein the enclosed space is located on an aircraft.

19. A system for fire suppression, the system comprising:
an enclosed space;
a fire detector located in the enclosed space;
a high rate discharge delivery system for supplying a first inert gas output at a high discharge rate to the enclosed space in response to a signal from the fire detector that a fire event has occurred, the first inert gas output configured for immediate suppression of the fire event in the enclosed space;
a low rate discharge delivery system for supplying a second inert gas output at a low discharge rate to the enclosed space after the first inert gas output, the second inert gas output configured for continuing suppression of the fire event in the enclosed space; and
an odorant discharge delivery system for supplying an odorant to the enclosed space, the odorant discharge delivery system including a delivery device for metering the odorant into the second inert gas output thereby providing an extended odiferous warning that inert gas is present in the enclosed space.

20. The system of claim 19, wherein the low rate delivery system includes an on board inert gas generation system.
